(19) United States
(12) Patent Application Publication
(10) Pub. No.: US 2010/0194651 A1
(43) Pub. Date: Aug. 5, 2010

(54) Multi-input multi-output antenna

(76) Inventor: Shi-Lin Huang, Jhongli City (TW)

Correspondence Address: Jackson Intellectual Property Group PLLC, 106 Starvale Lane, Shipman, VA, 22971, US

(21) Appl. No.: 12/149,689

(22) Filed: May 6, 2008

(51) Int. Cl. H01Q 1/00

(52) U.S. Cl. 343/730

(57) ABSTRACT

A multi-input multi-output antenna according to the present invention comprises a dipole antenna and a multi-slot antenna for inputting and outputting signals; wherein the multi-slot antenna has at least one metal sheet having an L-shaped section, which has a bend formed in the middle part thereof and has a vertical section and a horizontal section provided on the both sides respectively, and a slot which connects the vertical section and the horizontal section is disposed on the metal sheet, and the vertical section and the horizontal section have a notch having an opening formed therein respectively; thereby to make up an antenna capable of effectively isolating an input frequency from an output frequency without interfering with signals.

### BACKGROUND OF THE INVENTION

(a) Field of the Invention

The present invention relates to an improvement of a multi-input multi-output antenna. It aims to provide a multi-input multi-output antenna suitable to be installed in electrical equipment for the use of multi-input multi-output (MIMO) technology.

(b) Description of the Prior Art

The multi-input multi-output (MIMO) technology is a wireless transmission technology that can utilize multiple antennas at a transmitting end to independently send signals and simultaneously use multiple antennas at a receiving end to receive the signals and recover them to the prime information. The central idea of this technology is to utilize the spatial degrees of freedom provided by multiple transmitting antennas and multiple receiving antennas to effectively enhance the spectral efficiency of a wireless communication system, to increase the transmission speed and to improve the communication quality such that the data throughput and transmission distance of the system can be significantly increased without increase in the bandwidth or the overall transmit power expenditure.

As illustrated in FIG. 1A, there is an antenna device that is installed in electrical equipment for the use of multi-input multi-output technology. The antenna device of the prior art is mainly provided with two dipole antennas 10 for inputting and outputting signals. However, referring to FIG. 1B, the solid line represents one of the dipole antennas and the dotted line represents another dipole antenna. Owing to the same frequency as well as poor isolation, it easily results in interference between signals, and thus affects the received signal quality of the entire antenna device.

### SUMMARY OF THE INVENTION

In view of the above problems, the present invention is made to improve the aforementioned antenna device of the prior art and aims to provide a multi-input multi-output antenna suitable to be installed in electrical equipment for the use of multi-input multi-output (MIMO) technology.

To achieve the above objective, a multi-input multi-output antenna according to the present invention comprises a dipole antenna and a multi-slot antenna for inputting and outputting signals; wherein the multi-slot antenna has a metal sheet having an L-shaped section, and the metal sheet has a bend formed in the middle part thereof and has a vertical section and a horizontal section extending in the vertical and horizontal directions provided on the both sides of the bended portion respectively, and a slot which connects the vertical section and the horizontal section is disposed on the metal sheet, and the vertical section and the horizontal section have a notch having an opening formed therein respectively.

A multi-input multi-output antenna capable of effectively isolating an input frequency from an output frequency without interfering with signals is thereby comprised, and those notches each having an opening provide better impedance matching, better receive and transmission frequency bandwidths.

### BRIEF DESCRIPTION OF THE DRAWINGS

FIG. 1A is an antenna device of the prior art.

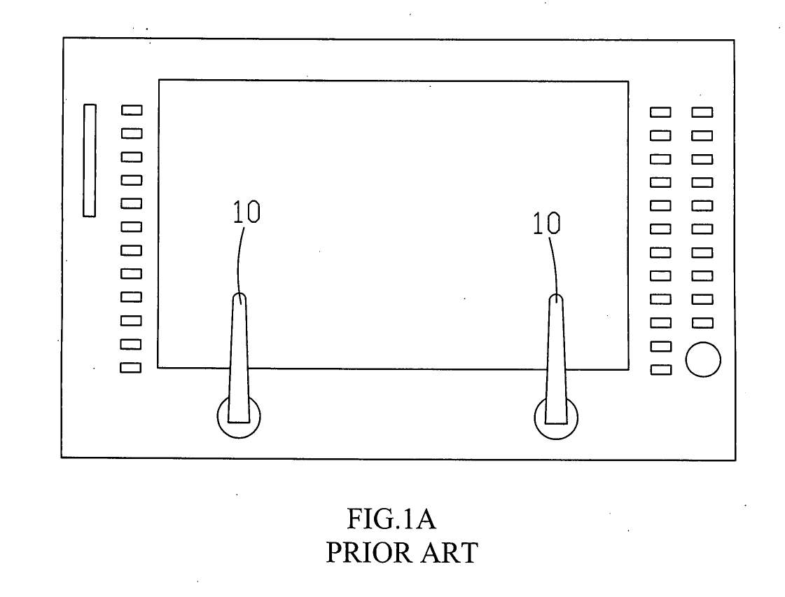

FIG. 1B is a view showing the reflection loss and voltage standing wave ratio of two sets of the conventional dipole antennas.

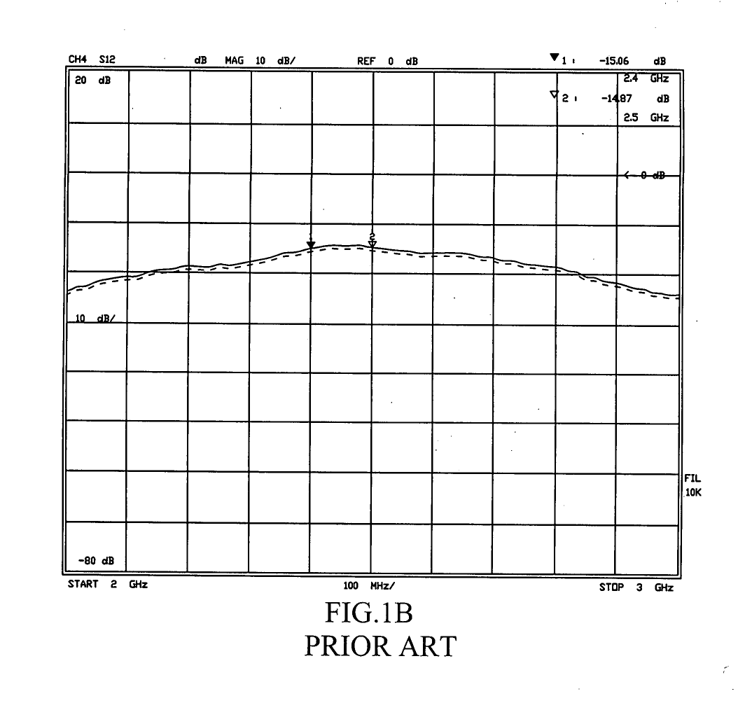

FIG. 2 is a schematic view showing a structure of a multi-input multi-output antenna according to the present invention.

FIG. 3 is a structure diagram showing an appearance of a multi-slot antenna according to a first embodiment of the present invention.

FIG. 4 is a cross-sectional view showing a structure of a multi-slot antenna according to a first embodiment of the present invention.

FIG. 5 is a view showing the reflection loss and voltage standing wave ratio of a dipole antenna according to the present invention and a multi-slot antenna according to the first embodiment.

FIG. 6 is a structure diagram showing an appearance of a multi-slot antenna according to a second embodiment of the present invention.

FIG. 7 is a structure diagram showing an appearance of a multi-slot antenna according to a third embodiment of the present invention.

### DETAILED DESCRIPTION OF THE PREFERRED EMBODIMENTS

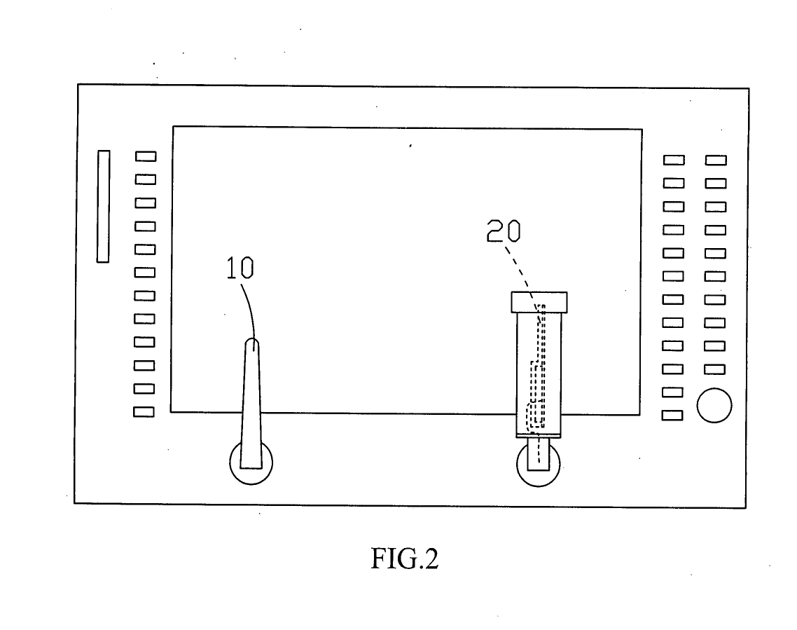

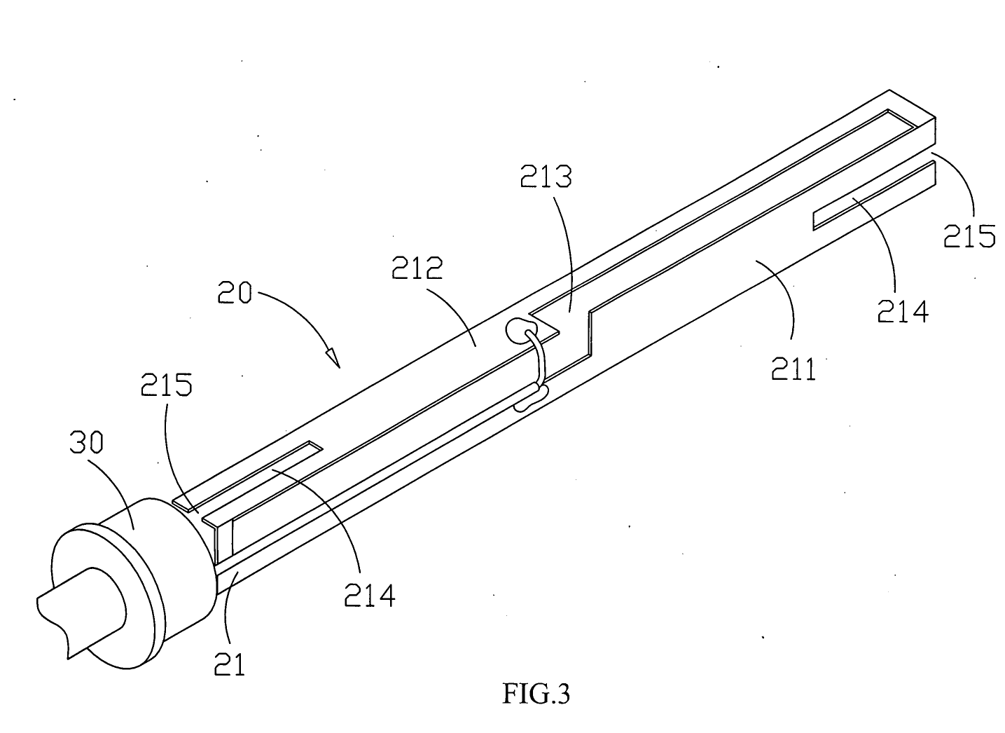

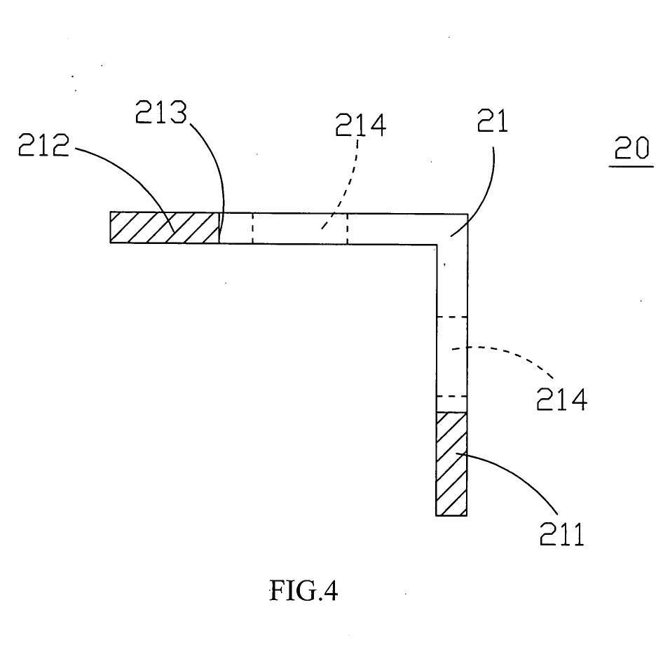

As illustrated in FIG. 2, the multi-input multi-output antenna according to the present invention comprises a dipole antenna 10 and a multi-slot antenna 20 for respectively inputting and outputting signals. Also, referring to FIGS. 3 and 4, a first embodiment of the present invention is shown; wherein the multi-slot antenna 20 has a metal sheet 21 having an L-shaped section, and a slot 213 is disposed on the metal sheet 21, and the metal sheet 21 has a bend formed in the middle part thereof and has a vertical section 211 and a horizontal section 212 extending in the vertical and horizontal directions provided on the both sides of the bended portion respectively.

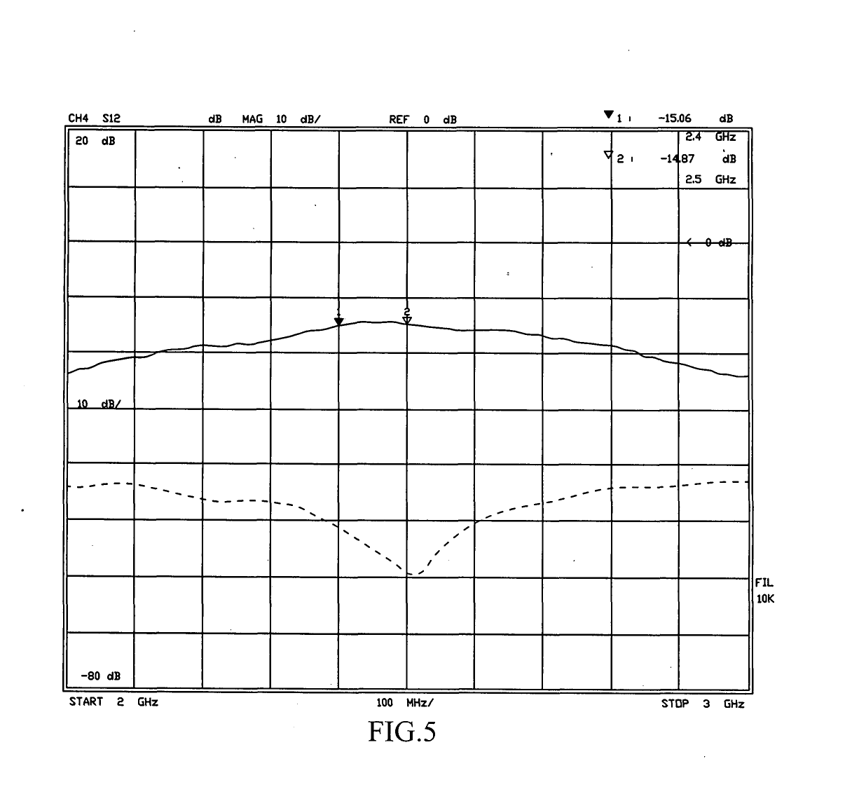

The slot 213 of the multi-slot antenna 20 connects the vertical section 211 and the horizontal section 212, and the vertical section 211 and the horizontal section 212 have a notch 214 having an opening 215 formed therein respectively. According to the present invention, the dipole antenna and the multi-slot antenna are used for inputting and outputting signals. The view showing the reflection loss and voltage standing wave ratio of the dipole antenna and the multi-slot antenna is shown in FIG. 5, wherein the solid line represents the dipole antenna and the dotted line represents the multi-slot antenna 20. Due to their different frequencies and better isolation, a multi-input multi-output antenna capable of effectively isolating an input frequency from an output frequency without interfering with signals, especially suitable for the use of multi-input multi-output (MIMO) technology, is thereby comprised, and those notches 214 each having an opening 215 can provide better impedance matching, better receive and transmission frequency bandwidths.

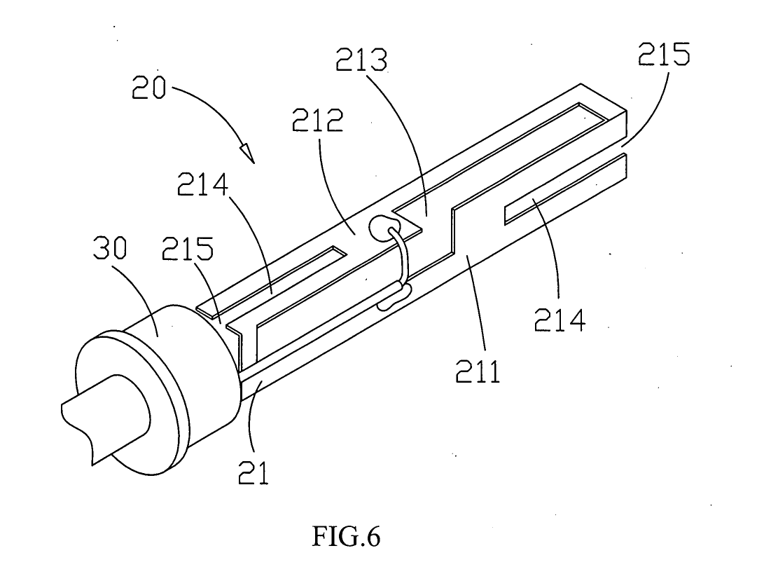

Also, one side of the metal sheet 21 can be used as a load point to make electrical connection with a transmission line 30. Furthermore, as illustrated in FIG. 6, the circumference of the slot 213 can be changed by changing the length of the metal sheet 21 to serve as a high-frequency antenna (in the case of the slot 213 of a shorter circumference) or a low-frequency antenna (in the case of the slot 213 of a longer circumference of).

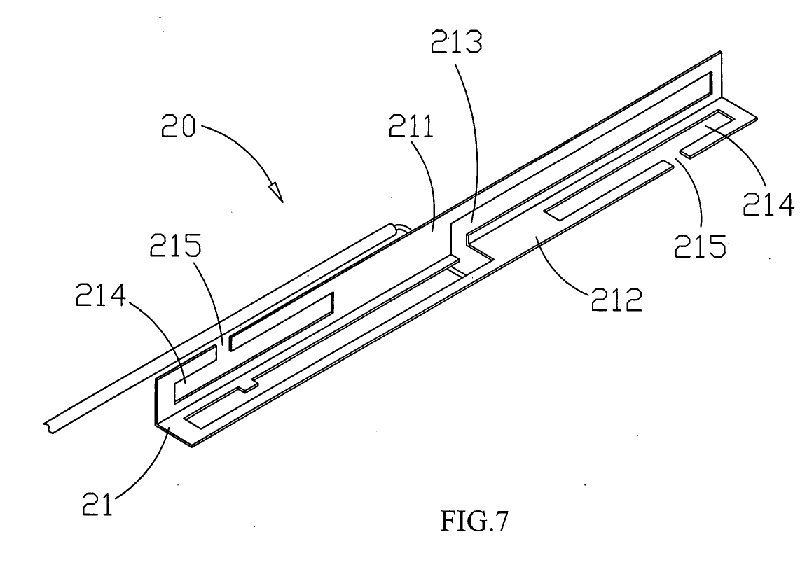

Alternatively, as illustrated in FIG. 7, the requirements for different input and output frequencies as well as different radiation characteristics can be achieved by changing the positions, sizes of the notches 214 and the directions of the openings 215 of the notches 214 in the vertical section 211 and the horizontal section 212.

In view of the above, the prevent invention provides a preferred feasible multi-input multi-output antenna, and the application for a utility model patent is duly filed accordingly. The technical contents and features of the present invention are disclosed above. However, anyone familiar with the technique could possibly make modify or change the details in accordance with the present invention without departing from the technologic ideas and spirit of the invention. Therefore, the protection scope of the present invention shall not be limited to what embodiment discloses, and should include various modification and changes that are made without departing from the technologic ideas and spirit of the present invention, and should be covered by the claims mentioned below.

I claim:

1. A multi-input multi-output antenna comprising:
a dipole antenna; and
a multi-slot antenna, which has at least one metal sheet having an L-shaped section, and the metal sheet has a bend formed in the middle part thereof and has a vertical section and a horizontal section extending in the vertical and horizontal directions provided on the both sides of the bended portion respectively, and a slot which connects the vertical section and the horizontal section is disposed on the metal sheet, and the vertical section and the horizontal section have a notch having an opening formed therein respectively.

2. The multi-input multi-output antenna as claimed in claim 1, wherein one side of the metal sheet in the multi-slot antenna is used as a load point to make electrical connection with a transmission line.

3. The multi-input multi-output antenna as claimed in claim 1, wherein the circumference of the slot is changed by changing the length of the metal sheet in the multi-slot antenna to serve as a high-frequency antenna or a low-frequency antenna.

4. The multi-input multi-output antenna as claimed in claim 1, wherein the requirements for different input and output frequencies are achieved by changing the positions, sizes of the notches and the directions of the openings of the notches in the vertical section and the horizontal section.

5. The multi-input multi-output antenna as claimed in claim 3, wherein the high-frequency antenna has a slot of a shorter circumference and the low-frequency antenna has a slot of a longer circumference.
